(19) United States
(12) Patent Application Publication
(10) Pub. No.: US 2025/0130563 A1
(43) Pub. Date: Apr. 24, 2025

(54) Method for Detecting an Anomaly in a Manufacturing Process

(71) Applicant: ABB Schweiz AG, Baden (CH)

(72) Inventors: Taisuke Minagawa, Barcelona (ES); Diego Vilacoba, Barcelona (ES); Ido Amihai, Heppenheim (DE); Martin Wolfgang Hoffmann, Mannheim (DE); Benjamin Kloepper, Mannheim (DE); Benedikt Schmidt, Heidelberg (DE)

(73) Assignee: ABB Schweiz AG, Baden (CH)

(21) Appl. No.: 19/007,799

(22) Filed: Jan. 2, 2025

Related U.S. Application Data
(63) Continuation of application No. PCT/EP2022/068797, filed on Jul. 6, 2022.

(51) Int. Cl. G05B 23/02

(52) U.S. Cl. CPC G05B 23/024

(57) ABSTRACT

A method for detecting an anomaly includes obtaining a time-series of historical process variables within a predefined time span; determining a cycle time of the historical process variables; clustering the historical process variables into clusters based on cycle time; arranging the clusters into a tree; storing the tree; obtaining a time-series of a plurality of current process variables, which correspond to the historic process variables; and detecting the anomaly of at least one device by identifying a cycle time of a current process variable that is longer than the cycle time of a corresponding historic variable.

### CROSS-REFERENCE TO RELATED APPLICATIONS

The instant application claims priority to International Patent Application No. PCT/EP2022/068797, filed Jul. 6, 2022, which is incorporated herein in its entirety by reference.

### FIELD OF THE DISCLOSURE

The present disclosure generally relates to manufacturing processes in an industrial plant and, more particularly, to detecting an anomaly in the manufacturing process and/or the plant.

### BACKGROUND OF THE INVENTION

Today's plants and/or manufacturing processes may comprise complex subsystems, machines, sensors, actuators and/or sub-processes. Hence, in at least some plants, a measurement of, e.g., an overall equipment effectiveness (OEE) and/or of KPIs (Key Performance Indicators) for quality assurance (QA) is performed. To get these values may be particularly complex and/or difficult when (many) IIOT devices (IIoT: industrial internet of things) are used in the process. Hence, a method for detecting an anomaly in said process is useful to cope with its complexity and/or to recognize malfunctions and/or possible damages.

### BRIEF SUMMARY OF THE INVENTION

The present disclosure generally describes a method for detecting an anomaly in a process, particularly in an industrial manufacturing process. In one aspect, the present disclosure describes a computer-implemented method for detecting an anomaly of at least one device in a manufacturing process, the method comprising the steps of: obtaining a time-series of a plurality of historic process variables within a predefined time span; determining, for each process variable of the plurality of the historic process variables, a cycle time of the process variable; clustering the plurality of process variables into a plurality of clusters, wherein the process variables of a cluster have the same cycle time; arranging the plurality of clusters to a hierarchical tree, the tree being based on the cycle time of the clusters, according to the similarity of the cycle time of the clusters; storing the hierarchical tree; obtaining a time-series of a plurality of current process variables, which correspond to the historic process variables; and detecting the anomaly of the at least one device, wherein the anomaly is defined by identifying a cycle time of a current process variable that is longer than the cycle time of the cluster containing the corresponding historic process variable.

In an industrial plant and/or manufacturing process, in many cases there is a huge amount of data collected for checking and/or controlling an overall equipment effectiveness (OEE) and/or of KPIs (Key Performance Indicators) for quality assurance (QA) of the plant and/or process. To get insights in the plant's subsystems, machines, sensors, actuators and/or sub-processes, a complexity reduction is useful. One approach of a complexity reduction is to structure the plant and/or process in a hierarchical way, e.g. by using one or more hierarchical tree(s), in order to create a top-down view for dealing efficiently with OEE/QA issues, and the devices (etc.) affecting them. As an example, a data set from a setup of one cell with three robots could result in over 300 variables. Hence, creation of KPIs may require a considerable effort for a user and/or operator of the plant to identify which variables are relevant and/or which of them may be an indicator of a malfunction.

For this method, firstly a basis with “historic” values is built, e.g. during a “normal” run of the plant. Thus, a time-series of a plurality of historic process variables is obtained within a predefined time span. The start, end, and/or duration of said time span may be determined by experts and/or selected—e.g. by experts and/or automated tools—from “historic” runs. The term “historic” designates older runs, e.g. runs that took place, e.g., one minute, hour, day, week, month, etc. before a current run (sometimes called “productive run”) of the plant and/or process. The “historic” runs may comprise particularly runs of a very quality, and/or runs that are considered as “usual” for said plant. The historic process variables may be obtained by any kind of sensors. The historic process variables may include summed-up values, e.g. a current of a complete subsystem, and/or inputs by an operator. There may be embodiments of the method that neglect a part of the historic process variables, e.g. historic process variables that are constant during the predefined time period. The result of the obtaining—and, optionally, the optimization—may be a so-called “base list”.

The “base list” may be used as a basis for determining, for each process variable of the plurality of the historic process variables, a cycle time of the process variable. Examples of a cycle time may be a duration of a rotation of a motor shaft, a distance between two “opening valves” moments, and other periodic events. For periodic events with a plurality of harmonics, the duration (i.e. the inverse) of the basis frequency may be considered as its cycle time. The result of the determining step is a list of historic process variables with individual cycle times. There may be embodiments of the method that get rid of variables whose cycle time is longer than the predefined time span. There may be embodiments where acyclic times are highlighted, e.g. times (and/or the related variables) that are not related to production, such as periodic maintenance, equipment recovery processes, e.g. cleaning of equipment, calibration, etc. For determining the cycle time of the process variable, one or more methods may be used. Examples may comprise algorithmic methods like comparison methods, evaluating an FFT (fast Fourier transform) of the variable, and/or using a trained ANN (Artificial Neural Network).

The plurality (or list) of the historic process variables can, then, be clustered into a plurality of clusters, wherein the process variables of a cluster have the same cycle time. The clustering may be done by, e.g., by a sorting algorithm, and/or by using distance measures, e.g. dynamic time warping, Levenshtein distance after SAX transformation, or Euclidian on a subset of extracted or engineered features or variable-subsets. For arranging the plurality of clusters to a hierarchical tree, either “agglomerative” (“bottom-up”, i.e. clusters are merged in direction up the tree) or “divisive” (“top-down”, i.e. a recursive split down the tree) approaches may be used. The result of the clustering may be a hierarchical tree (“dendrogram”) of the clusters, e.g. according to their similarity. In other words, the tree is based on the cycle time of the clusters, for example according to the similarity of the cycle time of the clusters. The hierarchical tree, based on the cycle time of the clusters, may be stored in a database. This hierarchical tree may be a method to find out a hierarchical order of the subsystems of the plant and/or the process. At least for some applications, gaining said hierarchical tree may already be beneficial, e.g. for getting insights into the structure of the plant. Furthermore, the hierarchical tree may be used for the anomaly detection.

In a current run (or “productive run”) of the plant and/or process, a time-series of a plurality of current process variables is obtained, the current process variables corresponding to the historic process variables. “Corresponding” may mean that process variables with the same designation are compared, e.g. “RPM of motor #15”, and/or the time-series that have the same or similar values. The definition of “similar” may depend on several factors, e.g. precision of measurement, tolerances of the devices, tolerable values ranges, and/or others. Based on the comparison of the current process variables with the historic process variables, the anomaly of the at least one device can be detected, wherein the anomaly is defined by identifying a cycle time of a current process variable that is significantly different to the cycle time of a corresponding historic variable.

The detecting may be used as a basis for subsequent actions, e.g. for outputting the anomaly, so that an expert can repair or start a maintenance of the device with the detected anomaly, and/or for modifying the operation of the at least one device to mitigate an effect of the anomaly. Optionally, algorithms may be used that pick up process cycles automatically and visualize process cycles/sub-cycles. Additionally or as an alternative, the detecting may be used to change control of the device, e.g. reduce the maximum allowed rotational speed and/or current, etc., of an electric motor. Additionally or as an alternative, the detecting may be used to stop a subsystem. Additionally or as an alternative, the detecting may be used to control a redundancy strategy, e.g. to change a load distribution among subsystems that run a so-called “warm redundancy strategy”. Additionally or as an alternative, the anomaly and/or a frequency and/or a severity of anomalies may be used for an OEE calculation of the industrial plant and/or process.

A variation of the cycle time may be caused by actions in sub-cycles-such as picking motion, in a welding process, inspection process, etc.—, which may require users to identify correct signals to map sub-cycles to variables. Identifying variables to map cycle/sub-cycles may be an efficient way to investigate root causes of problems such as process delays, and/or defects or decay in certain devices and/or subsystems.

### BRIEF DESCRIPTION OF THE SEVERAL VIEWS OF THE DRAWING(S)

FIG. 1 is a schematic of a relationship between values of a device and an anomaly of this device according to an embodiment of the present disclosure.

FIGS. 2a and 2b are schematics of an example of a clustering and an arranging the clusters to a hierarchical tree, according to an embodiment of the present disclosure.

FIGS. 3a and 3b are schematics of exemplary historic process variables and current process variables according to an embodiment of the present disclosure.

FIG. 4 is an exemplary schematic of anomalies of current process variables obtained in several runs according to an embodiment of the disclosure.

FIG. 5 is a schematic of an anomaly detection according to an embodiment of the disclosure.

FIG. 6 is a flowchart for a method in accordance with the disclosure.

FIG. 7 is a schematic of an anomaly detection according to an embodiment of the disclosure.

### DETAILED DESCRIPTION OF THE INVENTION

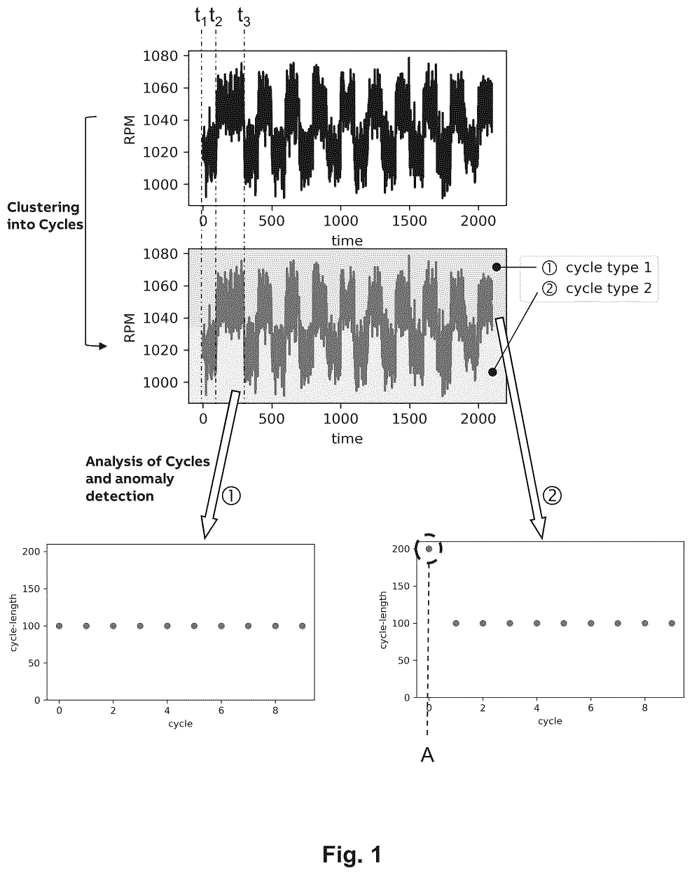

FIG. 1 shows schematically an example of a relationship between values of a device-here: of an electric motor—and an anomaly of this device. As can be seen in the upmost diagram of FIG. 1, the RPM-values of the electric motor differ in different time-periods. To provide an example, three points in time are marked, i.e. t1 to t3. It is clearly visible that the motor operates between t1 and t2, and between t2 and t3, in a different operation mode, respectively. In the following time span, the operation modes alternate analogously. In the different operation modes, also the cycle times differ. After clustering this process variable, two cycle types can be recognized, i.e. “cycle type 1” and “cycle type 2”; see the middle diagram of FIG. 1. The clustering step separates the values into values of “cycle type 1” (diagram bottom, left) and of “cycle type 2” (diagram bottom, right). After this clustering, the anomaly “A” can be recognized, in the “cycle type 2”.

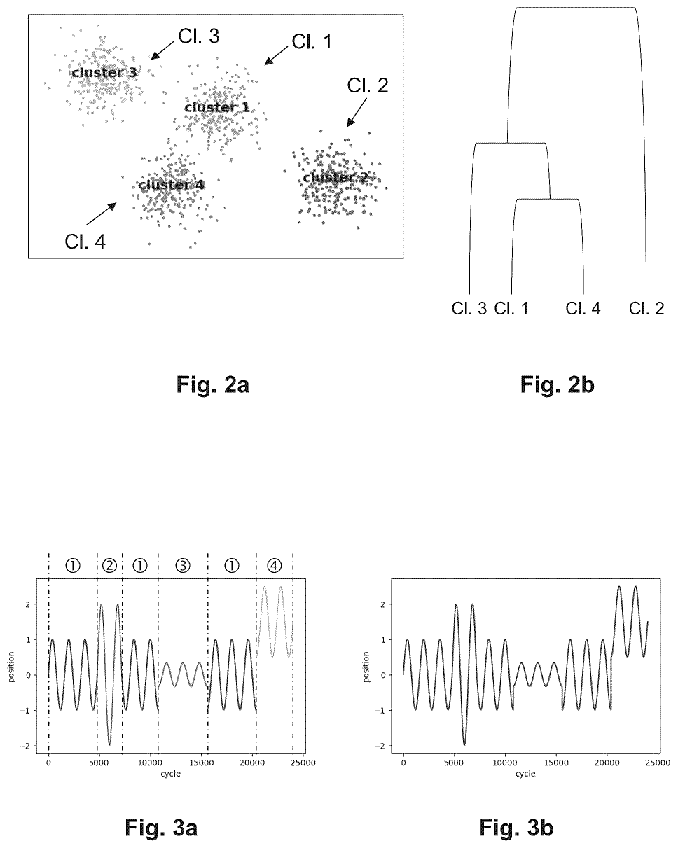

FIG. 2a shows schematically an example of a clustering, and FIG. 2b shows an arranging of the clusters to a hierarchical tree. The four clusters “Cl. 1” to “Cl. 4” have been clustered according to their xy-values, e.g. by using clustering methods as described above. It is intuitively visible that dot-clouds “Cl. 1” and “Cl. 4” are the closest ones, then “Cl. 3” and, then, “Cl. 2”. An ordering according to this proximity measure is reflected and depicted in the hierarchical tree of FIG. 2b.

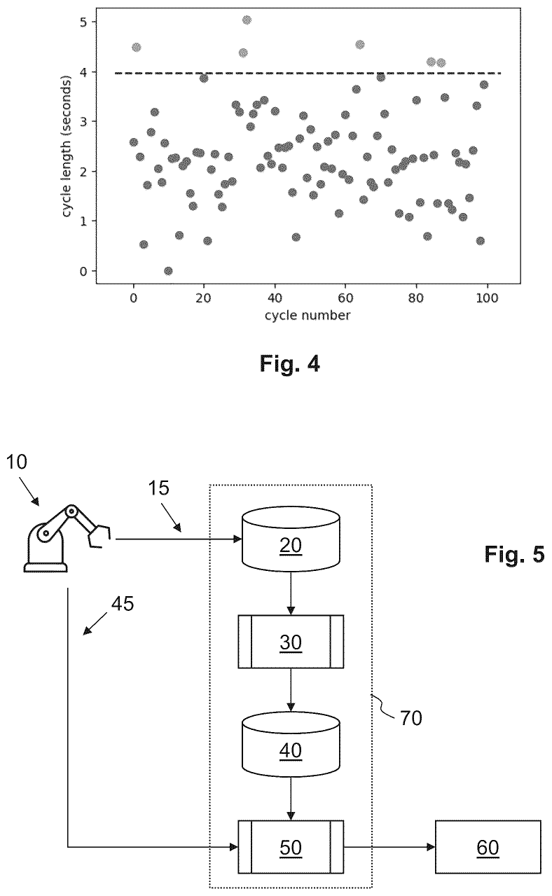

FIG. 3a shows schematically an example of historic process variables, and FIG. 2b shows current process variables. The historic process variables of FIG. 3a are clustered, as described above, into cycle types 1 to 4. The values of FIG. 3a may related to the clusters of FIG. 2a. It can be seen that the clustering enables or at least eases the recognizing of anomalies. FIG. 4 shows schematically an example of anomalies of current process variables obtained in several runs, according to an embodiment. The anomalies are defined by exceeding a predefined cycle length threshold, e.g. 4 seconds, as shown in FIG. 4. Each anomaly may be marked, e.g., with a time stamp, so that the device's current quality may be evaluated and/or effects like decay can be detected.

FIG. 5 shows schematically a sketch of the anomaly detection. Values of a device 10 may be obtained (see line 15) and fed into a database comprising the obtained values as historic process variables 20. After some processing—which may include determining a cycle time of each process variable and clustering them—by a computing sub-device or program 30, a hierarchical tree 40 is stored, the hierarchy based on the cycle time of the clusters. During a productive run, current process variables may be obtained (see line 45) and used, by a further computing sub-device or program 50 and along with the stored hierarchical tree 40, for detecting the anomaly of the at least one device 10. The result may be output to a display 60. Additionally or as an alternative, further actions may be taken, e.g. as described above. A computing system 70 may comprise the historic process variables 20 and/or storage means for them, the computing sub-device or program 30, the hierarchical tree 40 and/or storage means for them, and the further computing sub-device or program 50. Optionally, the display 60 and/or further devices and/or sub-devices or programs may be part of the computing system 70. The computing system 70 may run in the plant, close to it, and/or connected via a network to the plant.

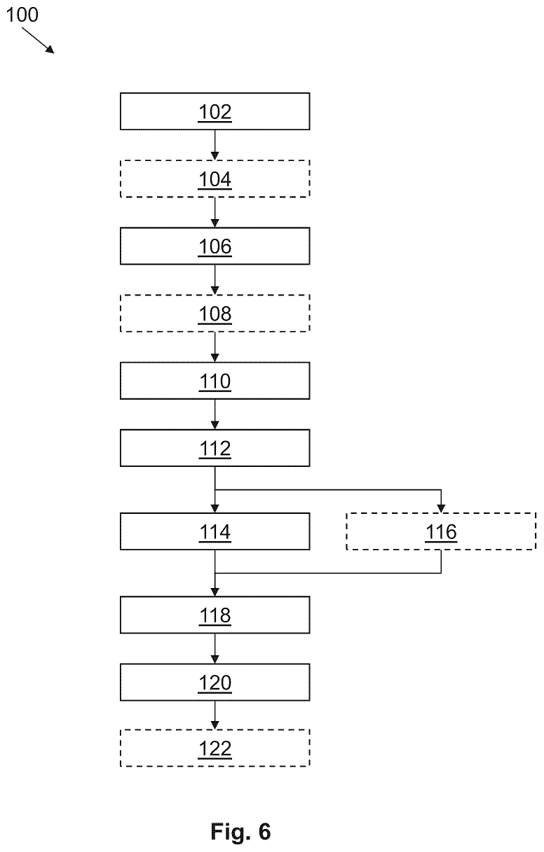

FIG. 6 shows a flow diagram 100 of a computer-implemented method for detecting an anomaly of at least one device 10 (see, e.g., FIG. 5) in a manufacturing process and/or a plant. In a step 102, a time-series of a plurality of historic process variables 20 within a predefined time span is obtained. In an optional step 104, a subset of process variables is removed, wherein the values of the subset of process variables are constant during the predefined time span. In a step 106, for each process variable of the plurality of the historic process variables 20, a cycle time of the process variable is determined. In an optional step 108, if the cycle time of a process variable of the plurality of process variables is greater than the predefined time span, said process variable is removed. In a step 110, the plurality of process variables is clustered into a plurality of clusters, wherein the process variables of a cluster have the same cycle time. In a step 112, the plurality of clusters is arranged to a hierarchical tree 40, the tree being based on the cycle time of the clusters. In a step 114, the hierarchical tree 40 is stored. In an optional step 116, the hierarchical tree 40 is visualized. In a step 118, a time-series of a plurality of current process variables is obtained, which correspond to the historic process variables 20. In a step 120, the anomaly of the at least one device 10 is detected, wherein the anomaly is defined by identifying a cycle time of a current process variable that is longer than the cycle time of a corresponding historic variable. In an optional step 122, the anomaly is output, e.g. on a display 60, and in an optional embodiment, the system takes action to mitigate the anomaly in the industrial plant process.

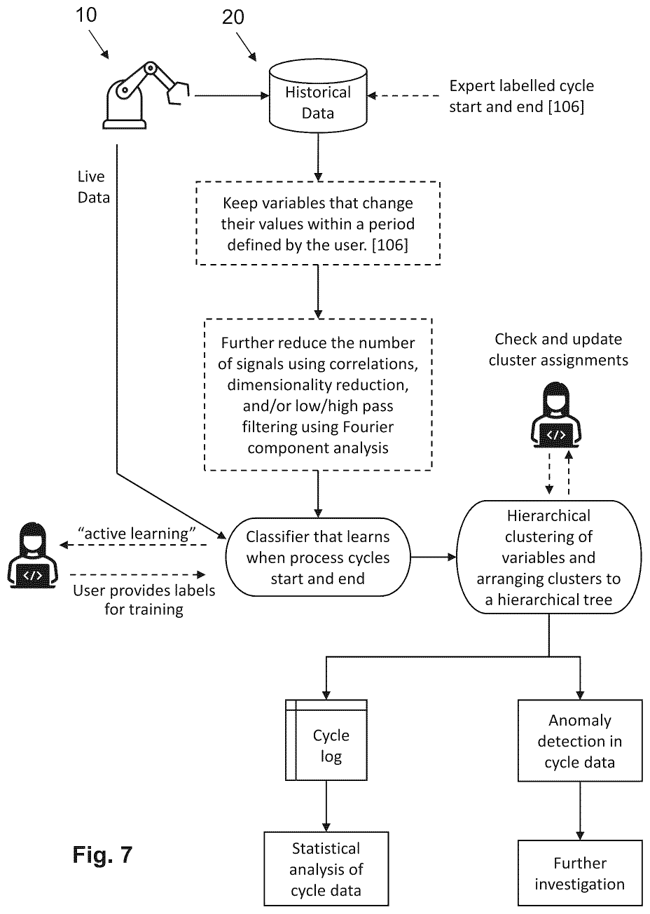

FIG. 7 shows schematically a sketch of the anomaly detection, according to an embodiment. Values of a device 10 may be obtained and fed into a database comprising the obtained values as historic process variables 20. Optionally, a subset of process variables is removed, wherein the values of the subset of process variables are constant during the predefined time span, thus keeping only variables that change their values within the predefined time span. Additionally or as an alternative, the number of signals may be (further) reduced, e.g. by using correlations, dimensionality reduction, and/or low/high pass filtering using Fourier component analysis. Then, live data may be obtained from device 10, and a classifier (and/or other methods) may be used for hierarchical clustering of the variables and/or for arranging clusters to a hierarchical tree 40. Optionally, the classifier may learn when process cycles start and end. This may be done by an “active learning” process, which may use an ANN. The training may be supported by user-provided labels. Further optionally, the hierarchical cluster assignments may be checked and/or and updated, e.g. by a supervising person and/or in an automated way. The hierarchical tree 40 may serve as a basis for the anomaly detection (and/or for a further problem detection) in the cycle data. Further investigation and/or actions may follow, based on the anomaly detection. Additionally or as an alternative, the hierarchical tree 40 may be stored, e.g. as a cycle log, which may further be used, e.g., for a statistical analysis of cycle data.

In various embodiments, the method in accordance with the disclosure further comprises the step of removing a subset of process variables after obtaining historic process variables, wherein the values of the subset of process variables are constant during the predefined time span. Constant values may indicate that a certain device is not involved in and/or is not relevant for a sub-process.

In various embodiments, the method further comprises the step of: After determining the cycle time, if the cycle time of a process variable of the plurality of process variables is greater than the predefined time span, removing said process variable. A very long cycle time may, e.g., be caused by a maintenance pause, etc.

In various embodiments, the determining the cycle time comprises following steps: Calculating a covariance matrix from the plurality of the historic process variables. Selecting a first set from the historic process variables whose standard deviation is above a first threshold. Selecting a second set from the first set of historic process variables whose squared correlation value is below a second threshold. Determining the cycle time.

The calculating step may be done only for continuous variables and/or non-binary variables. For categorical variables, a contingency table could be constructed, and variables could be removed based on the strength of their association with other categorical variables using statistical measures, e.g. Cramer's V. Selecting a second set may be performed by using dimensionality reduction techniques, e.g. principal component analysis, to reduce the data space. Selecting a second set may, additionally or as an alternative, be performed by low/high pass filtering to remove noisy frequencies from the data and subsequently perform an inverse Fourier transform. Determining the cycle time may be done by using supervised learning algorithms for an ANN on labelled historical data.

In various embodiments, the arranging the plurality of clusters to a hierarchical tree comprises a classification of the clusters, particularly by a classification tree, a logistic regression, a support vector classifier, and/or an artificial neural network.

In various embodiments, the method further comprises the step of: Before or after storing the hierarchical tree, visualizing the hierarchical tree. This may advantageously provide an intuitive insight into a structure of a complex plant and/or manufacturing process.

In various embodiments, the method further comprises the step of: After detecting the anomaly, outputting the anomaly. Additionally or as an alternative, further actions may be taken to control the manufacturing process, based on detecting the anomaly.

An aspect relates to a program element for executing the method described above and/or below, when running the program element on a processing unit.

An aspect relates to a computer-readable storage medium where a computer program or a computer program product as described above is stored on.

An aspect relates to a computing system, configured for executing the method as described above and/or below.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### LIST OF REFERENCE SYMBOLS

10 device
15 line
20 historic process variables
30 first sub-program
40 hierarchical tree
45 line
50 second sub-program
60 display
70 computing system
100 flow diagram
102-122 steps

What is claimed is:

1. A computer-implemented method for detecting an anomaly of at least one device in a manufacturing process, comprising:
obtaining a time-series of a plurality of historic process variables within a predefined time span;
determining, for each process variable of the plurality of the historic process variables, a cycle time of the process variable;
clustering the plurality of process variables into a plurality of clusters, wherein the process variables of a cluster have the same cycle time;
arranging the plurality of clusters to a hierarchical tree, the tree being based on the cycle time of the clusters, according to a similarity of the cycle time of the clusters;
storing the hierarchical tree;
obtaining a time-series of a plurality of current process variables that correspond to the historic process variables; and
detecting the anomaly of the at least one device, wherein the anomaly is defined by identifying a cycle time of the current process variable that is longer than the cycle time of the cluster containing the corresponding historic process variable.

2. The method of claim 1, further comprising removing a subset of process variables after obtaining historic process variables, wherein the values of the subset of process variables are constant during the predefined time span.

3. The method of claim 1, further comprising removing said process variable after determining the cycle time when the cycle time of a process variable of the plurality of process variables is greater than the predefined time span.

4. The method of claim 1, wherein determining the cycle time comprises:
calculating a covariance matrix from the plurality of the historic process variables;
selecting a first set from the historic process variables whose standard deviation is above a first threshold;
selecting a second set from the first set of historic process variables whose squared correlation value is below a second threshold;
computing a contingency table for categorical variables;
removing categorical variables whose association with other categorical variables is above a certain threshold, particularly using Cramer's V; and
determining the cycle time.

5. The method of claim 1, wherein arranging the plurality of clusters to a hierarchical tree comprises a classification of the clusters by a classification tree, a logistic regression, a support vector classifier, and/or an artificial neural network.

6. The method of claim 1, further comprising visualizing the hierarchical tree before or after storing the hierarchical tree.

7. The method of claim 1, further comprising outputting the anomaly after detecting the anomaly.

8. The method of claim 1, further comprising executing the method on a processing unit.
